(19) United States
(12) Patent Application Publication
(10) Pub. No.: US 2004/0076121 A1
(43) Pub. Date: Apr. 22, 2004

(54) Method for an internet communication

(76) Inventors: Seung-Eui Yang, Taejon (KR); Ja-Yun Jo, Taejon (KR)

Correspondence Address: D. PETER HOCHBERG CO. L.P.A., 1940 EAST 6TH STREET, CLEVELAND, OH, 44114, US

(21) Appl. No.: 10/416,356

(22) PCT Filed: Sep. 25, 2001
(86) PCT No.: PCT/KR01/01604

(30) Foreign Application Priority Data
Nov. 10, 2000 (KR) 2000/66715

(51) Int. Cl. H04J 1/16; H04L 1/00

(52) U.S. Cl. 370/253; 370/392

(57) ABSTRACT

The present invention relates to an Internet communication method, which can implement smooth bi-directional communication on the Internet between a user of a virtual IP address and a user of a real IP address. The present invention involves forming a client address information table by means of mapping, as a pair, an Internet protocol address (server-recognized IP address) obtained through a network socket and Internet protocol addresses (client-notified IP address) notified of directly by respective clients. Upon receiving a signal asking for an Internet protocol address of a corresponding client to be connected from a client terminal, the server-recognized IP address and the client-notified IP address of the corresponding client are read from said client address information table, which are then provided to the client terminal. Accordingly, by means of executing a connection by differentiating the client terminals having a real IP addresses from the client terminals having a virtual IP addresses, the present invention allows a user of the real IP address to call a user of the virtual IP address. In addition, the present invention results in smooth execution of Internet connections among users of different private networks.

### CROSS REFERENCE TO RELATED APPLICATION

This application is a national phase application of International Application No. PCT/KR01/01604, filed Sep. 25, 2001, and claims the priority of Korean application number 2000-66715, filed Nov. 10, 2000.

### FIELD OF THE INVENTION

The present invention relates to a method for an Internet communication by which communication is smoothly carried out between a user having a virtual IP address and a user having a real IP address.

### BACKGROUND OF THE INVENTION

The field of Internet has grown rapidly for years, and now innumerable host computers are connected to the Internet and many subordinate networks consisting of Private Network (PN) are providing services via gateway.

As shown in FIG. 1, which schematically illustrates connections between clients on the Internet, there can be various connections as follows:

1: the connection between terminals using a real IP address outside the PN gateway,

2: the connection from a terminal using a virtual IP address within the PN gateway to a terminal using a real IP address outside the gateway,

3: the connection between terminals using a virtual IP address within the same PN gateway,

4: the connection from a terminal using a real IP address outside the PN gateway to a terminal using a virtual IP address within the PN gateway (illustrated as the connection from RI to virtual IP 4 in FIG. 1), and

5: the connection from a terminal using a virtual IP address in one gateway to a terminal using a virtual IP address in another gateway (illustrated as the connection between virtual IP 2 and virtual IP 3 in FIG. 1).

Among the above various connections, the connections 1, 2 and 3 can be accomplished without difficulty. However, in the case of the connections 4 and 5, it is difficult for the user outside the gate to access the user having a virtual private IP address within the gate, because the users of the PN within the gateway do not use internationally certified real IP address but use a virtual private IP address.

### DISCLOSURE OF THE INVENTION

One object of the present invention is to provide a method for accessing terminals using a virtual IP address.

Another object of the present invention is to provide a method for Internet communication between a client terminal using a real IP address and a terminal in an arbitrary PN using a virtual IP address.

Still another object of the present invention is to provide a method for Internet communication between terminals in different PNs using a virtual IP address.

In order to accomplish above objects, the method for Internet communication according to the present invention comprises process 1 which generates a client address information table by mapping the IP address recognized through network socket (the server-recognized IP address) and the IP address notified directly by each client (the client-notified IP address) into a pair of addresses, process 2 which receives a signal from the first client terminal requesting the IP address of the second client terminal to be connected, process 3 which loads the server-recognized IP address and the client-notified IP address of the corresponding client from said client address information table, and process 4 which executes the connection by providing the client terminal with the information loaded by process 3, distinguishing the client terminal having a real IP address and the client terminal having a virtual IP address.

The method for an Internet communication according to the present invention is further characterized in that the connection between the first client terminal having a real IP address and the second client terminal having a virtual IP address in process 4 comprises step 1 wherein the first client provide the IP address of the first client and the IP address of the second client to the service server, step 2 wherein service server transfers the IP address information of the first client to the second client, and step 3 wherein the second client tries TCP/IP connection to the first client.

Another aspect of the method for Internet communication according the present invention is that the connection between the first client terminal having a virtual IP address of the first PN (Private Network) and the second client terminal having a virtual IP address of the second PN (Private Network) in process 4 comprises step 1 wherein the first client provides the IP address of the first client and the IP address of the second client to the service server, step 2 wherein service server generates a connection code which is internally unique in the service server, step 3 wherein the connection code information and the IP address information of a packet-switching server is transferred to the first client and the second client, and step 4 wherein the first client and the second client tries TCP/IP connection to the assigned packet-switching server through the same connection code assigned.

### BRIEF DESCRIPTION OF THE DRAWINGS

FIG. 1 is a schematic diagram illustrating the method for Internet connection according to the present invention.

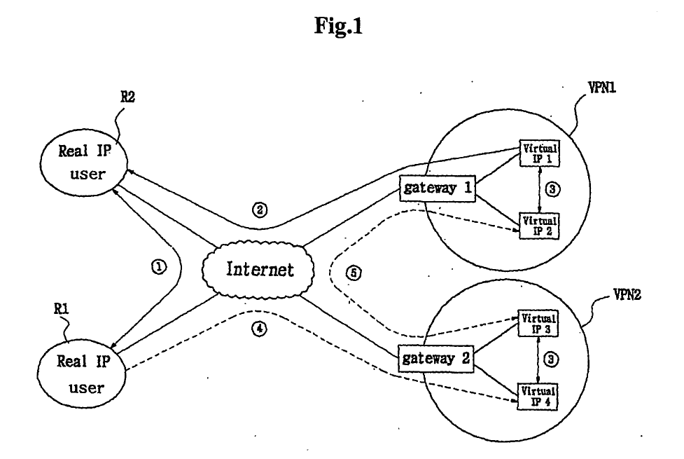

FIG. 2 is a flowchart indicating the method for Internet connection according to the present invention.

FIG. 3 is a schematic diagram illustrating the method for Internet connection corresponding the case 4 in FIG. 2.

FIG. 4 is a schematic diagram illustrating the method for Internet connection corresponding the case 5 in FIG. 2.

FIG. 5 is a modified schematic diagram of FIG. 4.

### BEST MODE FOR CARRYING OUT THE INVENTION

The description of the method for the Internet communication according to the present invention will be followed, in reference to the attached drawings.

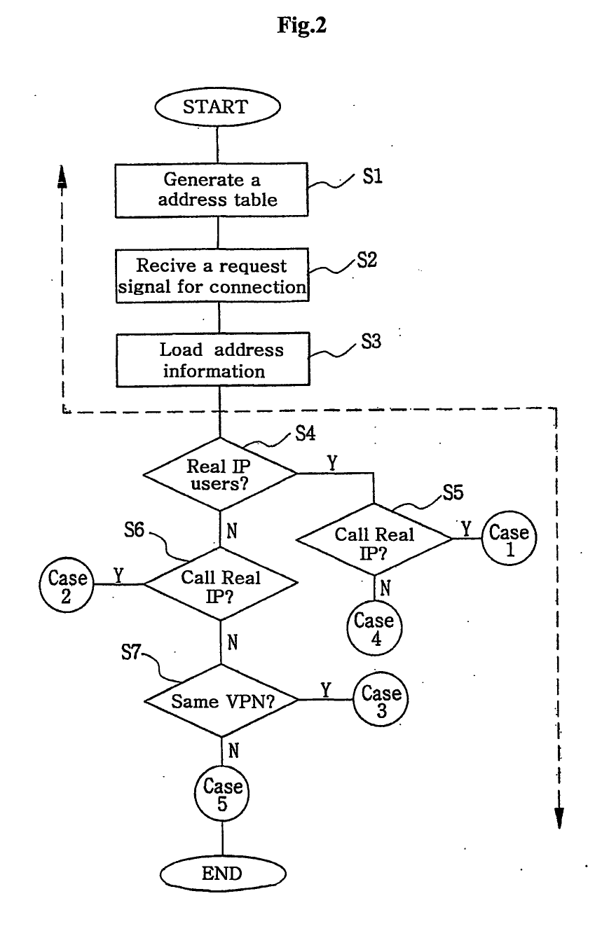

FIG. 2 is a flowchart illustrating the overall process of the method for an Internet connection according to the present invention. When the client accesses a service server, the client obtain its local IP address and transfer this address to the service server. The local IP address becomes the real IP address in case its terminal uses a certified real IP address, and becomes its own virtual IP address in case its terminal uses a virtual IP address. Here, the term “service server” refers to the server that the client accesses to obtain the desired services, i.e., the server for an Internet visual conference, the server for cyber education lectures, and so on. The service server, also, obtains the client's IP address through the network socket when it receives a request for a connection from the client. In case a terminal uses a virtual IP address, the IP address that the service server obtained directly through the network socket becomes the Gateway IP address for the PN to which the terminal belongs. This Gateway IP address is the real IP address for Internet. But, it can be the virtual IP address when the service server exists together with the Gateway server in the same device. The service server generates a client address information table with both the server-recognized IP address obtained through the network socket and the client-notified IP address notified from the client. With the client address information table, it is possible to determine whether the respective clients' virtual IP addresses should be used or not. If the “server-recognized IP address” is different from the “client-notified IP address”, it means the terminal uses a virtual IP address. As indicated above, the service server can exist together with a Gateway server in the same device, but in that case, it can be detected with the virtual IP address system whether the virtual IP address is used. Mostly, the service server and the Gateway server don't exist together in the same device, and it is now assumed that both of them don't exist together in the same device (S1).

Next, the service server receives the request signals from the clients requesting other client's IP address to which the client attempts to connect (S2).

And then, the service server loads the IP address information which includes the server-recognized IP address and the client-notified IP address, from the client's IP address table (S3).

The service server provides the above information loaded through the step S3 to the client's terminal, so that initiative for the operation of Internet connections will be handed over to the client's computer. At the moment, the IP address information of the client computer which requested the connection, should also be transmitted with both the “server-recognized IP address” and the “client-notified IP address”.

Receiving the destination IP address to which the client tries to connect, the client may implement the following connection process (S4˜S7). The client which tries to connect will be referred to as a first client, and the other client connected by the first client will be referred to as a second client.

First, it should be checked whether a first client uses the real IP address or not, i.e., it has to be checked whether the first client's “server-recognized IP address” and “the client-notified IP address” are identical or not (S4).

If the first client uses a real IP address, then it has to be checked whether the second client uses a real IP address. The process will proceed to Case 1 if a second client uses a real IP address, and to Case 4 if it uses a virtual IP address. The TCP/IP and UDP/IP connections are possible in Case 1, but those connections are impossible in Case 4 unless the process employs the method according to the present invention (S5).

When the first client doesn't use a real IP address, i.e., it uses a virtual IP address, it should be checked whether the second client uses a real IP address (S6). If the second client uses a real IP address, the process will proceed to Case 2. If the second client is not a user of a real IP address but a user of a virtual IP address, it should be checked again whether a first client's “server-recognized IP address” equals to the second client's “server-recognized IP address” or not. In other words, it is determined whether a second client uses the same PN (S7). Then, the process will proceed to Case 3 if the second client exists in the same PN. But the TCP/IP connection will be available with Case 5 if the second client uses PN which is different from the first client's.

Among above-mentioned cases, both the TCP/IP and UDP/IP connections are possible in Cases 1 and 3, but the UDP/IP connection is not available in Cases 2 allowing only the TCP/IP connection. Therefore, the method to solve the problem of Case 4 and 5 will be followed which correspond to the object of the present invention.

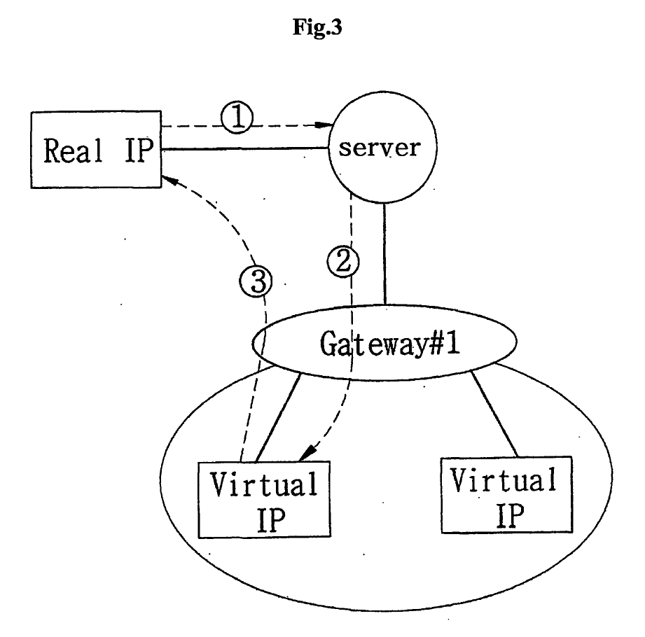

First, the connection method will be explained with regard to Case 4 (i.e., the first client is a user of a real IP address and the second client is a user of a virtual IP address) referring to the FIG. 3.

The first client requests a connection service from the service server, transmitting the IP addresses of its own and the IP addresses of a second client to the service server.

The service server notifies the second client of the above request, with the IP address of the requesting first client. Here, there exist channels already formed from the clients, between the service server and the respective clients.

The second client attempts to implement the TCP/IP connection toward the requesting first client, so that a new communication channel is established. This, of course, is conversion in the status of the caller and the called, however, all the processes are performed inside the software program and users won't be aware of that.

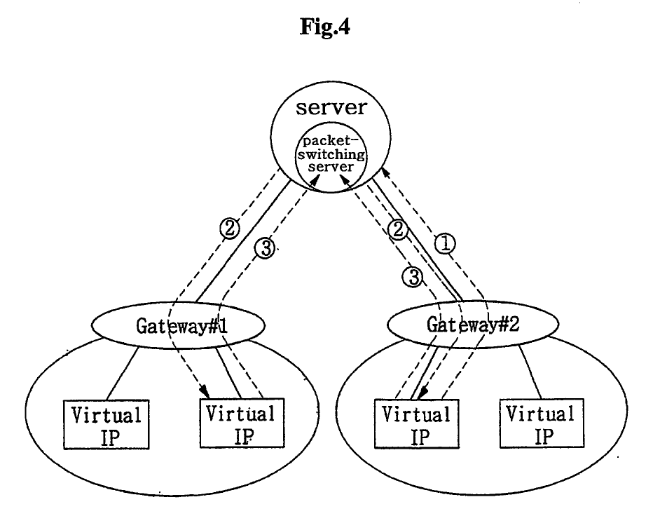

Next, the connection method will be explained with regard to Case 5 (i.e., the method for communication between the virtual IP address client located in different PNs) referring to the FIG. 4. In the explanations below, the first client refers to a user's terminal which uses a virtual IP address of a PN, and the second client refers to a user's terminal, to which the first client requests to access, which uses the other virtual IP address of a PN which is different from the IP address of the first client.

The first client requests a connection service from the service server, transmitting the IP address of the second client to the service server.

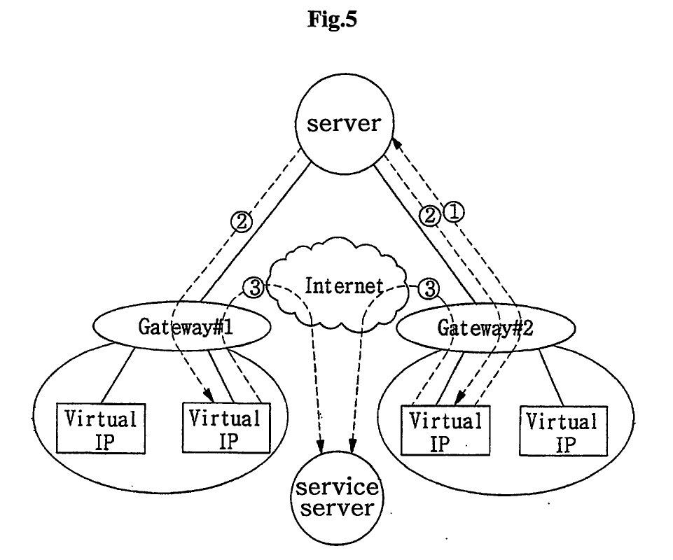

The service server generates a connection code which is internally unique, for example a Serial Integer Number, and transmits it to the first requesting client and the second client with the IP address of a “packet-switching server” that implements the packet-switching service. Here, the packet-switching server can exist in the server performing the Internet connection service according the present invention, and, as illustrated in the FIG. 5, any servers for Internet connection services can be utilized. Also, there exist channels already formed from the clients, between the service server and the respective clients.

Also, “the packet-switching server” can be organized with different multi-servers as required, the function of which can be included in the service server according to the present invention or any other service server. When the “packet-switching server” is in multi-operational, the service server according to the present invention or any other service server can be notified of their current service count by the respective “packet-switching servers”, and it can assign a new packet-switching service for a new connection in order to disperse the load.

(3) And then, the first and the second clients will attempt to access the “packet-switching server” with TCP/IP connection utilizing the same connection code assigned to the client. The term “packet” refers to a form of a parcel treated in the post office, which has freights divided into appropriate sizes and has formation tagged for each destinations. The packet in the field of data communication refers to binary numbers, i.e., a group of bits, including data and call signals. When data is transmitted especially in the manner of packet-switching, they are divided into basic transmission unit of packet before transmitting and are reassembled into the original data for processing after transmitting. When files such as e-mails, HTML files, GIF files and kinds of files are intended to transmitted from one place to the other on the Internet, the hierarchy of TCP/IP will divide those files into efficient sizes for transmission. The respective divided packets will be tagged with different numbers, and will include the Internet address for their destinations, and can be transmitted through various different routes. Accordingly, the “packet-switching server” will organize virtual channels according to their respective connection codes and assign them new communication channels by switching their packets. All of this process is accomplished internally in the software program, which the users won't notice.

### INDUSTRIAL APPLICABILITY

According to the present invention as described above, the user of the real IP address can connect to the user of the private network, and the accesses on the Internet between the users of the different private networks can be implemented smoothly.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications and variations that fall within the spirit and scope of the appended claims.

What is claimed is:

1. A method for an Internet communication comprising:
process 1 which generates a client address information table by mapping the IP address recognized through network socket (the server-recognized IP address) and the IP address notified directly by each client (the client-notified IP address) into a pair of addresses;
process 2 which receives a signal from the first client terminal requesting the IP address of the second client terminal to be connected;
process 3 which loads the server-recognized IP address and the client-notified IP address of the corresponding client from said client address information table; and
process 4 which executes the connection by providing the client terminal with the information loaded by process 3, distinguishing the client terminal having a real IP address and the client terminal having a virtual IP address,
the connection between the first client terminal having a real IP address and the second client terminal having a virtual IP address in process 4 comprising:
step 1 wherein the first client provide the IP address of the first client and the IP address of the second client to the service server;
step 2 wherein service server transfers the IP address information of the first client to the second client; and
step 3 wherein the second client tries TCP/IP connection to the first client.

2. The method for an Internet communication according to claim 1, wherein the connection between the first client terminal having a virtual IP address of the first PN (Private Network) and the second client terminal having a virtual IP address of the second PN (Private Network) in process 4 comprises:
step 1 wherein the first client provides the IP address of the first client and the IP address of the second client to the service server;
step 2 wherein service server generates a connection code which is internally unique in the service server;
step 3 wherein the connection code information and the IP address information of a packet-switching server is transferred to the first client and the second client; and
step 4 wherein the first client and the second client tries TCP/IP connection to the assigned packet-switching server through the same connection code assigned.

3. The method for an Internet communication according to claim 2, wherein said connection code is a serial number consisting of integer.

4. The method for an Internet communication according to claim 2, wherein said packet-switching server is a multi-server.

5. The method for an Internet communication according to claim 4, wherein said packet-switching server provides the service server with current service count information, so that said packet-switching server can be directed to provide a packet-switching service for a new connection.
